(19) United States
(12) Patent Application Publication
(10) Pub. No.: US 2020/0084019 A1
(43) Pub. Date: Mar. 12, 2020

(54) Blockchain Ranking Engine

(71) Applicant: Nebulas IO Limited, Road Town (VG)

(72) Inventor: Yiji Xu, Beijing (CN)

(21) Appl. No.: 16/125,575

(22) Filed: Sep. 7, 2018

(51) Int. Cl. H04L 9/06; G06F 17/30; G06F 9/46

(52) U.S. Cl. CPC H04L 9/0637; G06F 17/30958; G06F 2216/03; G06F 17/30539; G06F 9/466; G06F 17/30377

(57) ABSTRACT

Obtaining effective transactions in the blockchain network initiated within a user-specified time window; generating a first transaction graph from the obtained effective transactions, wherein the first transaction graph is a directed graph, wherein each vertex of the first transaction graph represents a computing node in the blockchain participating in an effective transaction, and wherein each directed edge of the first transaction graph represents a transfer of data between two computing nodes; calculating a weight representing the intensity of data transfer between two computing nodes in an effective transaction; generating a second transaction graph that is a largest weakly connected component of the first transaction graph; assigning a zero rank score to computing nodes outside of the largest weakly connected component; calculating a rank score for each of the computing nodes in the second transaction graph based on the distribution of edge weights in the second transaction graph.

### BACKGROUND

A distributed ledger system is a decentralized data storage system with data replicated and synced across multiple computing nodes. A blockchain is a continuously growing list of data records linked and secured using cryptographic technology. A blockchain can be managed by a distributed ledger system, i.e., a blockchain network, with each computing node in the distributed ledger system adhering to a blockchain protocol for inter-node communication and new blocks validation.

A blockchain network decentralizes data storage as every computing node independently maintains an updated copy of the blockchain. Each computing node of the blockchain network independently validates new blocks to be appended to the blockchain.

A blockchain network can host decentralized applications that execute across multiple computing nodes. An example decentralized application is a smart contract—a blockchain-based program that automatically executes when a set of specified conditions are met.

### SUMMARY

This specification describes technologies for evaluating and ranking computing nodes in a blockchain network. For example, the computing nodes can include mining nodes, transaction nodes, and deployed decentralized applications. The techniques include filtering transactions in the blockchain network, evaluating the amount of effective transactions at each computing node, and assigning a value to each computing node based on its associated effective transaction and the total amount of transactions in the blockchain network.

In general, one innovative aspect of the subject matter described in this specification can be embodied in methods that include the actions of obtaining all effective transactions in the blockchain network initiated within a user-specified time window, wherein an effective transaction is a transfer of data between a sender computing node and a different receiver computing node in the blockchain network; generating a first transaction graph from the obtained effective transactions, wherein the first transaction graph is a directed graph, wherein each vertex of the first transaction graph represents a computing node in the blockchain participating in an effective transaction, and wherein each directed edge of the first transaction graph represents a transfer of data between two computing nodes; calculating a weight to assign to each directed edge in the first transaction graph, wherein the weight represents the intensity of data transfer between two computing nodes in an effective transaction; generating a second transaction graph, wherein the second transaction graph is a largest weakly connected component of the first transaction graph; assigning a zero rank score to computing nodes outside of the largest weakly connected component; calculating a rank score for each of the computing nodes in the second transaction graph based on the distribution of edge weights in the second transaction graph.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Calculating a rank score for each of the computing nodes in the second transaction graph includes: adding a reference vertex to the second transaction graph; establishing bi-directional edges between the reference vertex and every other computing node in the second transaction graph; updating the weight of each edge based on the formula:

$${W}_{i , 0} = α \{ max ( {\sum }_{i , j \neq 0} {W}_{j , i} - {\sum }_{i , j \neq 0} {W}_{i , j} , 0 ) + λ C \}$$

$${W}_{0 , i} = β {\sum }_{i , j \neq 0} {W}_{i , j} + μ C$$

wherein W_{i,j} represents the weight of the edge starting at a computing node i and ending at another computing node j, wherein the reference vertex is represented as node 0, wherein C is the median of edge weights in the second transaction graph excluding edges starting or ending at the reference vertex, and α, λ, β, and μ are user-specified constants; generating a transition matrix H with N rows and N columns, wherein N is equal to the total number of nodes in the second transaction graph including the reference vertex, and wherein an element at i^{th} row and j^{th} column in the transition matrix H is defined as:

$${h}_{i , j} = \frac{{W}_{j , i}}{{\sum }_{k}^{N} {W}_{j , k}}$$

generating a rank score column vector P of N elements, defined as:

$$P = {[ 0 , \frac{1}{N} , \frac{1}{N} , … \frac{1}{N} ]}^{T}$$

iteratively updating the rank score column vector P by multiplying the transition matrix H with the rank score column vector P till the rank score column vector P reaches a steady state; and assigning to each computing node a rank score comprising a sum of (1) the respective value in the converged rank score column vector P and (2) the value corresponding to the reference vertex divided by N.

The computing nodes include mining nodes, transaction nodes, or decentralized applications. The decentralized applications include one or more smart contract applications. The first formula is a linear combination of two normal distribution functions, and wherein the first formula maps a ratio of outgoing data amount to a sum of outgoing and incoming data amount to a weight for an edge. The mining difficulty for each computing node varies based on the computing node's rank score in the blockchain. The method further includes: updating the weight of each edge by multiplying the weight by a sum of coinage values of the computing nodes associated with the edge, and wherein the coinage value for each computing node is a product of the total units of data stored by the computing node with the number of days the units of data have been stored.

Particular embodiments of the subject matter described in this specification can be implemented so as to realize one or more of the following advantages. Techniques for ranking blockchains provide a universal measure of the value of application and data across different blockchain networks. As a result, blockchain developers can have an objective reference to compare computing nodes, smart contracts, and other decentralized applications regardless of blockchain network. Consensus algorithms can be implemented based on the ranking of different nodes in the blockchain network.

The details of one or more embodiments of the subject matter of this specification are set forth in the accompanying drawing and description below. Other features, aspects, and advantages of the subject matter will become apparent from the description, the drawings, and the claims.

### BRIEF DESCRIPTION OF THE DRAWINGS

FIG. 1 is a schematic depiction of an example blockchain.

FIG. 2 is a schematic depiction of an example distributed ledger system.

FIG. 3 is a schematic depiction of an example workflow for ranking a computing node on a blockchain network.

FIG. 4 is a flowchart of an example process for ranking a computing node in a blockchain network.

Specific embodiments of the invention will now be described in detail with reference to the accompanying figures. Like elements in the various figures are denoted by like reference numerals for consistency.

### DETAILED DESCRIPTION

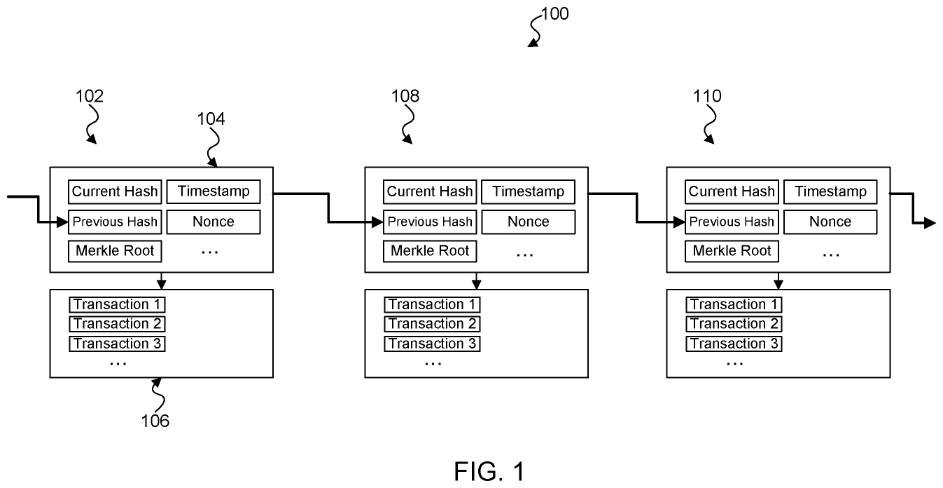

FIG. 1 is a schematic depiction of an example blockchain 100. A blockchain is a linked list of blocks. Each block is a container data structure including at least (1) a block header and (2) a transaction list. For example, the blockchain 100 includes three example blocks, a block 102, a block 108, and a block 110 linked to each other.

A block header, e.g., the block header 104 for the block 102, includes metadata describing key aspects of the corresponding block. Example block header metadata include current hash, timestamp, previous hash, nonce, Merkle root, etc. Each of these metadata can be represented as a string value. For example, a block header can be represented by table 1:

TABLE 1

| | |
|---|---|
| Current hash | “000000000000000000448b43be29890ca780b2b21e2e- |
| | 2a0e53e04269d135abc8” |
| Previous hash | “0000000000000000002e22f7b842d8ec98d67e5ae504- |
| | 1e263e3be7e3cea9bbb6” |
| Timestamp | “2018-04-30 19:02:08” |
| Nonce | “2069396004” |
| Merkle Root | “bcd5048e2c5a9960fb285dde4693a3ba7830ea69b8cf98- |
| | 76214d31cd321f1dac” |

A transaction list, e.g., the transaction list 106 for the block 102, includes a list of transactions that occurred in a distributed ledger system, i.e., a peer-to-peer blockchain network that implements the blockchain. Each transaction in a transaction list occurred between the current timestamp and the time when the previous block was appended to the blockchain. An example transaction happens when one computing node, e.g., a transaction node, in the blockchain network, sends data, such as digital currency supported by the blockchain, to another computing node in the blockchain network. Another example transaction can include the distribution of digital currency to mining nodes by the blockchain network's consensus. Another example transaction can include a change of state of the current blockchain by the execution of a smart contract.

Each transaction can be described by (1) a sender address in the blockchain network, (2) a receiver address in the blockchain network, (3) transferred data, (4) a timestamp of the transaction, and (5) a unique transaction ID. Each of these fields can be represented as a string value. For example, a transaction can be represented by table 2:

TABLE 2

| | |
|---|---|
| Sender Address | “134Qu1v9KenipLUCnZpC95GrBXh7S6vWog” |
| Receiver Address | “1FC6uZgnctM1BbVoQYZLCcN6o4KrgQZowE” |
| Timestamp | “2018-05-01 05:26:37” |
| Data | “0.6183096 BTC” |
| Transaction ID | “559dc5d4b58371da04c3719819e869a3b70bc33614- |
| | 5167d8bf662a480fece9bb” |

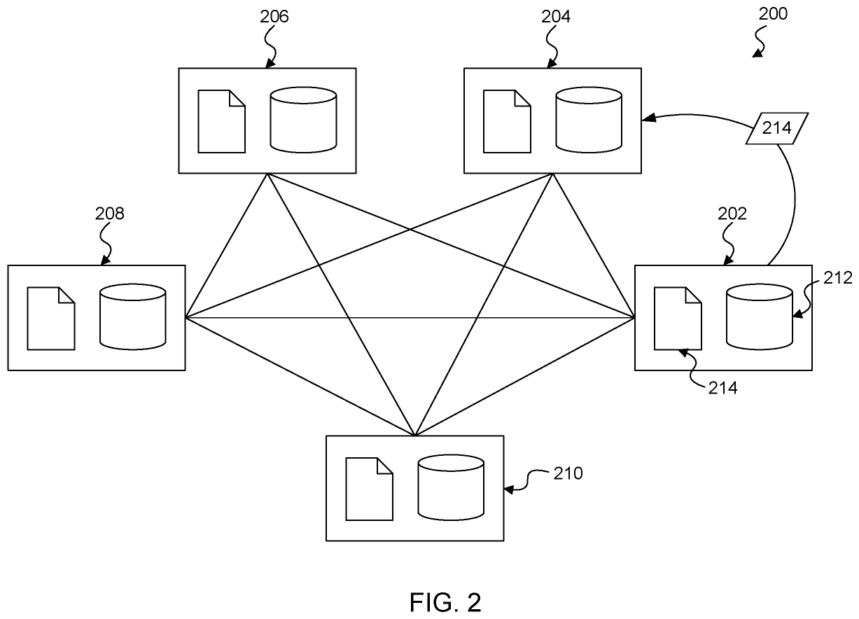

Each transaction will be broadcast to and validated in the blockchain network using a process called mining. Mining will be explained in more details below with reference to FIG. 2.

Current hash is a unique digital identifier of the current block. A hash is a cryptographic digital signature generated by feeding some selected data into a cryptographic hash function. A cryptographic hash function is a special class of hash functions that maps data of arbitrary size to a bit string of a fixed size. For example, the cryptographic hash function used in table 1 has an output of a 32-bit string value. A cryptographic hash function useful for a blockchain is typically required to have five main properties:
1. It is deterministic so that the same data will result in the same hash.
2. It is quick to compute.
3. It is infeasible to recreate the data from its hash except by trying all possible messages.
4. A small change in the data will change the hash extensively.
5. It is infeasible to find two different data with the same hash value.

An example cryptographic hash function is the SHA-256 algorithm, which is used by the Bitcoin blockchain network. Other example cryptographic hash functions include BLAKE, BLAKE2, KECCAK-256, CryptoNight, etc.

Current hash is calculated by feeding block data, e.g., string values in the block header and the transaction list, to a cryptographic hash function specified in the blockchain protocol. Given that each block has unique block data and that it is infeasible to find two different data with the same hash value (property 5 mentioned above), current hash is unique for every block.

Previous hash is a hash pointer which points to the previous block. Previous hash has value equivalent to current hash of the previous block. As a result, except for the very first block, each block is connected to another block (the first block, or the “genesis block,” is generated automatically by the blockchain protocol). This design causes data on a blockchain to be immutable. For example, if a hacker wishes to change data in one block, data in all blocks must be changed since every block contains a bit of hashed information from another block, and a small change in the data will change the hash extensively.

Timestamp identifies the time when the current block was appended to the blockchain. Computing nodes can reference a dedicated time-reporting server to record consistent timestamp across the blockchain network.

Nonce is an arbitrary random value that is used in the cryptographic hash function to control the hash output. In order to add a new block to a blockchain, a special type of computing node “mining node” randomly chooses a nonce value and repeatedly hashes the block data including the chosen nonce till the hash output satisfies a specified condition. For example, the condition for adding a new block shown in table 1 is that the hash output (current hash) must have eighteen leading “0s.” Details on the process of adding a block to a blockchain are described below with reference to FIG. 2.

Merkle root is the top hash value produced by feeding data in a transaction list into a Merkle tree. A Merkle tree is a binary tree in which every leaf node is a hash of a data block and every non-leaf node is a hash of its two child nodes. Merkle root uniquely identifies the list of transactions associated with each block.

In some implementations, a reward is given to the mining node which first discovered a nonce to satisfy the specified condition for appending blocks. For example, the reward can be some digital currency specified by the blockchain. This incentives users to participate as mining nodes in the blockchain network to spend computing resources to compete in the so-called mining process described below. Each mining node maintains a copy of the blockchain locally, and communicates with other mining nodes to broadcast and validate new transactions.

FIG. 2 is a schematic depiction of an example distributed ledger system.

A distributed ledger system is a decentralized data storage system with data replicated and synced across multiple computing nodes. For example, a distributed ledger system can be implemented as a blockchain network. A blockchain network is a network of computing nodes set to maintain a blockchain, e.g., the blockchain 100 of FIG. 1, according to a specified blockchain protocol. For example, FIG. 2 shows a blockchain network 200 including five computing nodes 202, 204, 206, 208, and 210. Each computing node is independent from and connected to every other node. Computing nodes can assume different functions such as mining nodes, transaction nodes, decentralized applications, etc.

Each computing node includes a runtime that executes a specified blockchain protocol, e.g., a protocol 214 in the computing node 202. The blockchain protocol specifies rules including the conditions for allowing a mining node to add a new block to the blockchain, the frequency of adding new blocks, the type of data included in a block, or the amount of rewards to be distributed for appending the blockchain, etc.

Each computing node also includes a data storage area, e.g., a data storage area 212 of the computing node 202, for storing current information of the blockchain.

In some implementations, the blockchain network comprises one or more transaction nodes. Transaction nodes are a type of computing nodes in the blockchain network that do not implement the full blockchain protocol. For example, a transaction node does not spend computing resource to validate other transactions, but rely on mining nodes for such a task. A transaction node functions exclusively to send and receive data in the blockchain network with other computing nodes.

A transaction in the blockchain network is initiated when a transfer of data occurs. For example, the blockchain maintained in the blockchain network 200 can be a record of digital currency transactions among computing nodes. Each of the computing nodes 202, 204, 206, 208 and 210 can act as a transaction node and/or a mining node. That is to say, each of the computing nodes in FIG. 2 can both send and receive data, and validate new blocks to the blockchain. The computing node 202 can initiate a transaction 214 by sending some amount of digital currency to the computing node 204.

To have the blockchain record the transaction 214, the computing node 202 broadcasts this transaction to every other computing node in the blockchain network 200. Another computing node, e.g., the computing node 210, receives the transaction and performs two different tasks. First, the computing node 210 will verify that the transaction 214 is a valid transaction. For example, the computing node 210 can look into records in the existing blockchain to verify that the computing node 202 has the sufficient amount of digital currency to transfer to the computing node 204. Next, the computing node 210 initiates a “mining” process in an attempt to become the first node to add this transaction to the blockchain.

Mining is a process in which a computing node spends computing resource to search for a special string (nonce) that causes the hash output of the block (current hash) to satisfy a specified condition. If a computing node is the first node to find the appropriate nonce, then the computing node is given certain rewards and the transaction is appended to the blockchain after other computing nodes validate the proposed nonce. Each computing node's mining power is limited by its specific computer architecture. For example, a computing node with a faster CPU clock rate has greater mining power compared to one with a slower clock rate.

As an example condition, for a block with some new transactions to be added to the blockchain, a nonce must be found such that when the nonce combined with other data in the block header and transaction list, and fed to the cryptographic hash function (e.g. SHA-256), the output string must begin with a certain number of leading “0s.” Since it is infeasible to recreate the data from its hash except by trying all possible inputs (property 3 of hash function), there only exists a brute force solution and it takes a very large number of trials to find the right nonce.

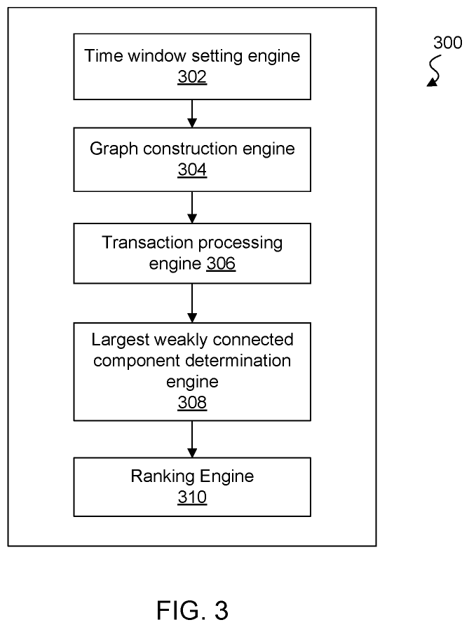

In some implementations, a computing node's mining power is restricted by conditions such as the amount of digital currency held by the computing node, or the rank of the computing node in the blockchain network. For example, a computing node that holds 1% of all available digital currency supported by the blockchain network can only mine at most 1% of all new blocks. In another example, a computing node with a higher rank in a blockchain network receives reduced mining difficulty compared to a node with lower rank. Ranking of computing nodes in a blockchain network is described below with respect to FIG. 3.

If the computing node 202 does have sufficient digital currency, and the computing node 210 is the first computing node to find the correct nonce, the computing node 210 will broadcast its finding to every other computing node in the blockchain. If the nonce and the transactions in the new block are validated, the new block will be added to the blockchain. Each computing node in the blockchain network will have an updated copy of the blockchain.

FIG. 3 is a block diagram of an example workflow 300 for ranking a computing node in a blockchain network. The computing node can be a mining node, a transaction node, or a decentralized application executed in the blockchain network. The ranking is based on the relative importance of each computing node as described in more detail below.

The workflow includes a time window setting engine 302, a graph construction engine 304, a transaction processing engine 306, a largest weakly connected component determination engine 308, and a ranking engine 310.

Each of the engines 302-310 can be implemented as a computer application executed on a dedicated server or as a decentralized application executed across multiple computing nodes in the blockchain network.

The time window setting engine 302 identifies all effective transactions in the blockchain network within a user-specified time window. For example, each transaction in the blockchain network can be represented as a 4-tuple (s, r, a, t), where “s” represents a sender's address, i.e., a unique identifier in the blockchain network that identifies the sender's computing node, “r” represents a receiver address, “a” represents the transferred data, and “t” represents a user-specified timestamp. For example, if the blockchain records a transfer of digital currency among computing nodes, “a” is the amount of digital currency for each transaction. The time window setting engine 302 can use a default time window such as one month. A transaction is deemed to be effective if and only if: (1) the transferred data is not null (e.g., the digital currency transferred is not zero), (2) the sender's address is different from the receiver's address, and (3) the timestamp is within the time window. Therefore, the time window setting engine 302 can prevent an attacker from manipulating a computing node's ranking in the blockchain network by only returning effective transactions.

The graph construction engine 304 takes the effective transactions returned by the time window setting engine 302 as inputs and constructs a directed weighted graph. On the directed weighted graph, each vertex represents a computing node's address in the blockchain, and each directed edge represents data transfer activities between the two associated computing nodes. For each directed edge, the graph construction engine 304 selects a number of the most significant data transfer activities, and assigns a weight to the directed edge equal to the net amount of data transferred during those activities. For example, if the blockchain records transfers of digital currency among computing nodes, and a first node has transferred 10 units, 5 units, 8 units, and 7 units of digital currency to a second node within a specified time window, then the weight assigned to the directed edge from the first node to the second node is 18 (10+8) if the graph construction engine 304 uses the top two largest data transfer activities.

The transaction processing engine 306 computes a coinage value and an encourage value for each computing node based on data transferred to and from the computing node. The transaction processing engine 306 then uses the coinage value and the encourage value to update the weight associated with each directed edge. The coinage value is a product of the amount of digital currency held by a computing node and the number of days that the computing node has held the currency. For example, a computing node that has held 100 units of digital currency for 10 days will receive a coinage value of 1000. Initially, each computing node receives a coinage value of zero.

The transaction processing engine 306 computes the encouragement value according to the following equation:

$$Encouragement Value = {F}_{encouragement} ( \frac{Out Amount}{In Amount + Out Amount} )$$

where the encouragement function F encouragement can be any suitable user-specified function. For example, it can be a linear combination of two normal distribution functions, which outputs peak value when the amount of digital currency transferred out is of some ratio to the amount of digital currency transferred in. Out Amount is the net amount of data (e.g., digital currency) transferred out from the computing node in a specified time window, and the In Amount is the net amount of data transferred into the computing node in the same time window.

The transaction processing engine 306 can use the encouragement value to update edge weights. For example, an edge weight can be updated by multiplying the original edge weight with the sum of the corresponding nodes' encouragement value and coinage value.

The largest weakly connected component determination engine 308 receives the constructed graph with updated edge weights as input, and returns the largest weakly connected component of the graph. A graph is weakly connected if, when considering it as an undirected graph, for every pair of distinct vertices there exists an undirected path connecting the two nodes. The largest weakly connected component determination engine 308 assigns a low importance score to computing nodes outside of the obtained largest weakly connected graph. In the rare case where there exist multiple largest weakly connected components in the graph, all the components can be returned and processed.

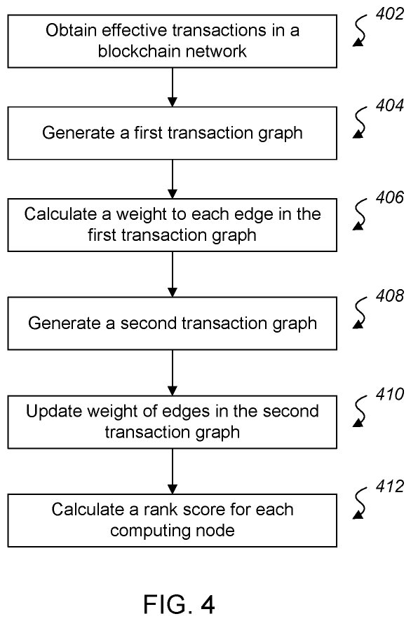

The ranking engine 310 next ranks vertices, i.e., computing nodes in the blockchain network, on the largest weakly connected component according to steps described below with respect to FIG. 4.

FIG. 4 is a flowchart of an example process for ranking a computing node in a blockchain network. The example process can be performed by a system of one or more computers. For example, the process may be performed by the ranking engine 310 of FIG. 3.

The process ranks computing nodes based on each node's relative importance in the blockchain network as determined by the amount and quality of data transfer. For example, the process can assign a greater rank score to a computing node receiving a larger amount of incoming data. The rank score can reflect one or more of: (1) the frequency and scale of the node's transactions, (2) the scope and depth of the node's data liquidity, and (3) the interoperability of the node in the blockchain network.

The system obtains all effective transactions in a blockchain network (402). For example, an effective transaction can be a transfer of data between two different computing nodes within a user-specified time window. The system can perform this step using, for example, the time window setting engine 302 of FIG. 3.

The system generates a first transaction graph (404). The transaction graph is a weighted directed graph with vertices representing the computing nodes in the blockchain network. Each directed edge in the first transaction graph represents a transfer of data, e.g., digital currency, from one computing node to another. The system can perform this step using, for example, the graph construction engine 304 of FIG. 3.

The system calculates a weight for each directed edge in the first transaction graph (406). For example, the weights can be generated according to the steps described in FIG. 3 using the graph construction engine 304.

The system generates a second transaction graph (408). The second transaction graph is the largest weakly connected component of the first transaction graph. For example, the system can generate the second transaction graph using the largest weakly connected component determination engine 308 of FIG. 3.

The system updates edge weights in the second transaction graph (410). The system can first insert a reference node (vertex 0) in the second transaction graph, and establish bi-directional edges between the reference node and every other node in the second transaction graph. The system can assign weights to the newly added edges according to the equation below:

$${W}_{i , 0} = α \{ max ( {\sum }_{i , j \neq 0}^{ } {W}_{j , i} - {\sum }_{i , j \neq 0}^{ } {W}_{i , j} , 0 ) + λ C \}$$

$${W}_{0 , i} = β {\sum }_{i , j \neq 0}^{ } {W}_{i , j} + μ C$$

W_{i,j} represents the weight of a directed edge starting at a computing node i and ending at another computing node j. For example, W_{i,0} represents the weight of an edge ending at the reference vertex. C is the median of edge weights in the second transaction graph excluding edges starting or ending at the reference vertex. α, λ, β, and μ are user-specified constants.

The system calculates a rank score for each computing node based on the second transaction graph with the updated weights. For example, the system assigns a low importance score to nodes outside of the second transaction graph.

The system can use a Markov Chain process to rank computing nodes belonging to the second transaction graph. The transition matrix H for this Markov Chain process is an N×N matrix, with N being the total number of vertices in the second transaction graph. Elements in the transition matrix H are specified by:

$${h}_{i , j} = \frac{{W}_{j , i}}{{\sum }_{k}^{N} {W}_{j , k}} , 0 \leq i , j , k \leq N$$

The rank score vector P is a column vector including the rank score for each of the vertices in the second transaction graph. The reference vertex is initialized with a score of 0, and every other vertex in the second transaction graph is initialized with a score of 1/N:

$${P}^{0} = {[ 0 , \frac{1}{N} , \frac{1}{N} , … \frac{1}{N} ]}^{T}$$

The rank score vector is then iteratively updated in a Markov Chain process with the transition matrix H till P reaches a steady state:

Pⁿ=H*Pⁿ⁻¹,n≥1

The rank score for each computing node is the corresponding value in the rank score vector P added to the reference node value divided by N:

$$Rank Score of Computing Node X = P [ x ] + \frac{P [ 0 ]}{N}$$

Rank scores calculated in this way represent a flux of data at each computing node during a blockchain transaction. Larger transactions (e.g. digital currency transfers) at a computing node produce larger rank scores.

Rank scores are difficult for an attacker to manipulate and truthfully reflect the relative importance of a computing node in the blockchain network.

Rank scores provide a fair and universal way to measure and explore the value of blockchain ecosystems. For example, since rank scores are blockchain-agonistic, they can be used to compare values of computing nodes or applications executed on different blockchain networks. In another example, ranks scores can be used to implement a blockchain search engine that searches and returns valuable applications in the entire blockchain world. In another example, rank scores can be used to adjust mining difficulties for different computing nodes. Computing nodes with higher rank scores face reduced difficulty in mining new blocks. As a result, computing nodes and blockchain developers are incentivized to contribute value to the blockchain ecosystem.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for ranking computing nodes in a blockchain network, comprising:
obtaining all effective transactions in the blockchain network initiated within a user-specified time window, wherein an effective transaction is a transfer of data between a sender computing node and a different receiver computing node in the blockchain network;
generating a first transaction graph from the obtained effective transactions, wherein the first transaction graph is a directed graph, wherein each vertex of the first transaction graph represents a computing node in the blockchain participating in an effective transaction, and wherein each directed edge of the first transaction graph represents a transfer of data between two computing nodes;
calculating a weight to assign to each directed edge in the first transaction graph, wherein the weight represents the intensity of data transfer between two computing nodes in an effective transaction;
generating a second transaction graph, wherein the second transaction graph is a largest weakly connected component of the first transaction graph;
assigning a zero rank score to computing nodes outside of the largest weakly connected component; and
calculating a rank score for each of the computing nodes in the second transaction graph based on the distribution of edge weights in the second transaction graph.

2. The computer-implemented method of claim 1, wherein calculating a rank score for each of the computing nodes in the second transaction graph comprises:
adding a reference vertex to the second transaction graph;
establishing bi-directional edges between the reference vertex and every other computing node in the second transaction graph;
updating the weight of each edge based on the formula:
$${W}_{i , 0} = α \{ max ( {\sum }_{i , j \neq 0}^{ } {W}_{j , i} - {\sum }_{i , j \neq 0}^{ } {W}_{i , j} , 0 ) + λ C \}$$
$${W}_{0 , i} = β {\sum }_{i , j \neq 0}^{ } {W}_{i , j} + μ C$$
wherein W_{i,j} represents the weight of the edge starting at a computing node i and ending at another computing node j, wherein the reference vertex is represented as node 0, wherein C is the median of edge weights in the second transaction graph excluding edges starting or ending at the reference vertex, and α, λ, β, and μ are user-specified constants;
generating a transition matrix H with N rows and N columns, wherein N is equal to the total number of nodes in the second transaction graph including the reference vertex, and wherein an element at i^{th} row and j^{th} column in the transition matrix H is defined as:
$${h}_{i , j} = \frac{{W}_{j , i}}{{\sum }_{k}^{N} {W}_{j , k}}$$
generating a rank score column vector P of N elements, defined as:
$$P = {[ 0 , \frac{1}{N} , \frac{1}{N} , … \frac{1}{N} ]}^{T}$$
iteratively updating the rank score column vector P by multiplying the transition matrix H with the rank score column vector P till the rank score column vector P reaches a steady state; and
assigning to each computing node a rank score comprising a sum of (1) the respective value in the converged rank score column vector P and (2) the value corresponding to the reference vertex divided by N.

3. The computer-implemented method of claim 1, wherein the computing nodes comprise mining nodes, transaction nodes, or decentralized applications.

4. The computer-implemented method of claim 4, wherein the decentralized applications comprise one or more smart contract applications.

5. The computer-implemented method of claim 1, wherein the first formula is a linear combination of two normal distribution functions, and wherein the first formula maps a ratio of outgoing data amount to a sum of outgoing and incoming data amount to a weight for an edge.

6. The computer-implemented method of claim 1, wherein the mining difficulty for each computing node varies based on the computing node's rank score in the blockchain.

7. The computer-implemented method of claim 2, further comprising:
updating the weight of each edge by multiplying the weight by a sum of coinage values of the computing nodes associated with the edge, and wherein the coinage value for each computing node is a product of the total units of data stored by the computing node with the number of days the units of data have been stored.

8. A system comprising one or more computers and one or more storage devices storing instructions that when executed by the one or more computers cause the one or more computers to perform operations comprising:
obtaining all effective transactions in the blockchain network initiated within a user-specified time window, wherein an effective transaction is a transfer of data between a sender computing node and a different receiver computing node in the blockchain network;
generating a first transaction graph from the obtained effective transactions, wherein the first transaction graph is a directed graph, wherein each vertex of the first transaction graph represents a computing node in the blockchain participating in an effective transaction, and wherein each directed edge of the first transaction graph represents a transfer of data between two computing nodes;
calculating a weight to assign to each directed edge in the first transaction graph, wherein the weight represents the intensity of data transfer between two computing nodes in an effective transaction;
generating a second transaction graph, wherein the second transaction graph is a largest weakly connected component of the first transaction graph;
assigning a zero rank score to computing nodes outside of the largest weakly connected component; and
calculating a rank score for each of the computing nodes in the second transaction graph based on the distribution of edge weights in the second transaction graph.

9. The system of claim 8, wherein calculating a rank score for each of the computing nodes in the second transaction graph comprises:
adding a reference vertex to the second transaction graph;
establishing bi-directional edges between the reference vertex and every other computing node in the second transaction graph;
updating the weight of each edge based on the formula:
$${W}_{i , 0} = α \{ max ( {\sum }_{i , j \neq 0}^{ } {W}_{j , i} - {\sum }_{i , j \neq 0}^{ } {W}_{i , j} , 0 ) + λ C \}$$
$${W}_{0 , i} = β {\sum }_{i , j \neq 0}^{ } {W}_{i , j} + μ C$$
wherein W_{i,j} represents the weight of the edge starting at a computing node i and ending at another computing node j, wherein the reference vertex is represented as node 0, wherein C is the median of edge weights in the second transaction graph excluding edges starting or ending at the reference vertex, and α, λ, β, and μ are user-specified constants.
generating a transition matrix H with N rows and N columns, wherein N is equal to the total number of nodes in the second transaction graph including the reference vertex, and wherein an element at i^{th} row and j^{th} column in the transition matrix H is defined as:
$${h}_{i , j} = \frac{{W}_{j , i}}{{\sum }_{k}^{N} {W}_{j , k}}$$
generating a rank score column vector P of N elements, defined as:
$$P = {[ 0 , \frac{1}{N} , \frac{1}{N} , … \frac{1}{N} ]}^{T}$$
iteratively updating the rank score column vector P by multiplying the transition matrix H with the rank score column vector P till the rank score column vector P reaches a steady state; and
assigning to each computing node a rank score comprising a sum of (1) the respective value in the converged rank score column vector P and (2) the value corresponding to the reference vertex divided by N.

10. The computer-implemented method of claim 8, wherein the computing nodes comprise mining nodes, transaction nodes, or decentralized applications.

11. The computer-implemented method of claim 10, wherein the decentralized applications comprise one or more smart contract applications.

12. The computer-implemented method of claim 8, wherein the first formula is a linear combination of two normal distribution functions, and wherein the first formula maps a ratio of outgoing data amount to a sum of outgoing and incoming data amount to a weight for an edge.

13. The computer-implemented method of claim 8, wherein the mining difficulty for each computing node varies based on the computing node's rank score in the blockchain.

14. The computer-implemented method of claim 9, further comprising:
updating the weight of each edge by multiplying the weight by a sum of coinage values of the computing nodes associated with the edge, and wherein the coinage value for each computing node is a product of the total units of data stored by the computing node with the number of days the units of data have been stored.

15. A non-transitory computer storage medium encoded with a computer program, the computer program storing instructions that when executed by one or more computers cause the one or more computers to perform operations comprising:
obtaining all effective transactions in the blockchain network initiated within a user-specified time window, wherein an effective transaction is a transfer of data between a sender computing node and a different receiver computing node in the blockchain network;
generating a first transaction graph from the obtained effective transactions, wherein the first transaction graph is a directed graph, wherein each vertex of the first transaction graph represents a computing node in the blockchain participating in an effective transaction, and wherein each directed edge of the first transaction graph represents a transfer of data between two computing nodes;
calculating a weight to assign to each directed edge in the first transaction graph, wherein the weight represents the intensity of data transfer between two computing nodes in an effective transaction;
generating a second transaction graph, wherein the second transaction graph is a largest weakly connected component of the first transaction graph;
assigning a zero rank score to computing nodes outside of the largest weakly connected component; and
calculating a rank score for each of the computing nodes in the second transaction graph based on the distribution of edge weights in the second transaction graph.

16. The computer-implemented method of claim 15, wherein calculating a rank score for each of the computing nodes in the second transaction graph comprises:
adding a reference vertex to the second transaction graph;
establishing bi-directional edges between the reference vertex and every other computing node in the second transaction graph;
updating the weight of each edge based on the formula:
$${W}_{i , 0} = α \{ max ( {\sum }_{i , j \neq 0}^{ } {W}_{j , i} - {\sum }_{i , j \neq 0}^{ } {W}_{i , j} , 0 ) + λ C \}$$
$${W}_{0 , i} = β {\sum }_{i , j \neq 0}^{ } {W}_{i , j} + μ C$$
wherein W_{i,j} represents the weight of the edge starting at a computing node i and ending at another computing node j, wherein the reference vertex is represented as node 0, wherein C is the median of edge weights in the second transaction graph excluding edges starting or ending at the reference vertex, and α, λ, β, and μ are user-specified constants.
generating a transition matrix H with N rows and N columns, wherein N is equal to the total number of nodes in the second transaction graph including the reference vertex, and wherein an element at i^{th} row and j^{th} column in the transition matrix H is defined as:
$${h}_{i , j} = \frac{{W}_{j , i}}{{\sum }_{k}^{N} {W}_{j , k}}$$
generating a rank score column vector P of N elements, defined as:
$$P = {[ 0 , \frac{1}{N} , \frac{1}{N} , … \frac{1}{N} ]}^{T}$$
iteratively updating the rank score column vector P by multiplying the transition matrix H with the rank score column vector P till the rank score column vector P reaches a steady state; and
assigning to each computing node a rank score comprising a sum of (1) the respective value in the converged rank score column vector P and (2) the value corresponding to the reference vertex divided by N.

17. The computer-implemented method of claim 15, wherein the computing nodes comprise mining nodes, transaction nodes, or decentralized applications.

18. The computer-implemented method of claim 17, wherein the decentralized applications comprise one or more smart contract applications.

19. The computer-implemented method of claim 15, wherein the first formula is a linear combination of two normal distribution functions, and wherein the first formula maps a ratio of outgoing data amount to a sum of outgoing and incoming data amount to a weight for an edge.

20. The computer-implemented method of claim 15, wherein the mining difficulty for each computing node varies based on the computing node's rank score in the blockchain.
